(19) United States
(12) Patent Application Publication
(10) Pub. No.: US 2026/0204753 A1
(43) Pub. Date: Jul. 16, 2026

(54) BATTERY PACK AND BATTERY PACK MANUFACTURING METHOD

(71) Applicant: TOYOTA JIDOSHA KABUSHIKI KAISHA, Toyota-shi (JP)

(72) Inventors: Tomo FUKAMI, Nagoya-shi (JP); Shunsuke ISOBE, Okazaki-shi (JP); Yoshinori SHIBATA, Nagoya-shi (JP); Takumi SHIGENO, Toyota-shi (JP)

(73) Assignee: TOYOTA JIDOSHA KABUSHIKI KAISHA, Toyota-shi (JP)

(21) Appl. No.: 19/387,669

(22) Filed: Nov. 13, 2025

(30) Foreign Application Priority Data
Jan. 16, 2025 (JP) 2025-006386

(51) Int. Cl. H01M 50/557; H01M 50/209; H01M 50/528; H01M 50/566

(52) U.S. Cl. CPC H01M 50/557; H01M 50/209; H01M 50/528; H01M 50/566

(57) ABSTRACT

A battery pack includes a plurality of battery cells arrayed adjacently to each other in a width direction, and at a terminal piece portion, on one side in the width direction, of a battery cell on another side in the width direction out of these battery cells, a joining portion is welded to an external terminal, and a flat portion of this joining portion is capable of applying a biasing force to the one side in the width direction. On the other hand, at a terminal piece portion, on the other side in the width direction, of a battery cell on the one side in the width direction out of these battery cells, a joining portion is welded to an external terminal, and a flat portion of this joining portion is capable of applying a biasing force to the other side in the width direction.

### CROSS-REFERENCE TO RELATED APPLICATION

This application claims priority to Japanese Patent Application No. 2025-006386 filed on January 16, 2025. The disclosure of the above-identified application, including the specification, drawings, and claims, is incorporated by reference herein in its entirety.

### BACKGROUND

### 1. Technical Field

The present disclosure relates to a battery pack and a battery pack manufacturing method.

### 2. Description of Related Art

WO 2017/130706 discloses an disclosure related to a power supply device. In this power supply device, when welding a bus bar to an electrode terminal provided on an upper part of a battery cell, the bus bar is pressed against the battery cell using a jig.

### SUMMARY

However, when the above prior art is adopted in a power supply device including battery cells with electrode terminals provided on the sides thereof, there is a need to secure space between the battery cells to dispose a jig when welding the bus bar and the electrode terminal, which is undesirable from the perspective of energy density of an electricity storage device. That is to say, the above prior art has room for improvement in terms of stably connecting the electrodes provided on the sides of the battery cells, while ensuring energy density.

In view of the above circumstances, an object of the present disclosure is to provide a battery pack and a battery pack manufacturing method that can stably connect electrodes provided on the sides of battery cells while ensuring energy density.

A battery pack according to a first aspect includes a first battery cell and a second battery cell that are arrayed adjacently to each other in an array direction, in which the first battery cell includes a first external terminal that is provided on a portion, on one side in the array direction, of a first case housing a first electrode assembly, and that is also electrically connected to a first electrode of the first electrode assembly, and a first terminal piece portion that is made of metal, and that includes a first joining portion that is welded to the first external terminal, and a first flat portion that is provided integrally with the first joining portion, the first flat portion being planar in shape with a thickness direction matching the array direction, and that is also configured to apply a biasing force to the one side in the array direction, and the second battery cell includes a second external terminal that is provided on a portion, on another side in the array direction, of a second case housing a second electrode assembly, and that is also electrically connected to a second electrode of the second electrode assembly, and a second terminal piece portion that is made of metal, and that includes a second joining portion that is welded to the second external terminal, and a second flat portion that is provided integrally with the second joining portion, the second flat portion being planar in shape with the thickness direction matching the array direction, and that is also configured to apply a biasing force to the other side in the array direction and also is welded to the first flat portion.

The battery pack according to the first aspect includes the first battery cell and the second battery cell that are arrayed adjacently to each other in the array direction. The first battery cell includes a first external terminal that is provided on a portion, on one side in the array direction, of the first case housing the first electrode assembly, i.e., on the side of the first battery cell and that is also electrically connected to the first electrode of the first electrode assembly, and the first terminal piece portion that is made of metal and that is welded to the first external terminal.

On the other hand, the second battery cell includes the second external terminal that is provided on a portion, on another side in the array direction, of the second case housing the second electrode assembly, i.e., on the side of the second battery cell and that is also electrically connected to the second electrode of the second electrode assembly, and the second terminal piece portion that is made of metal and that is welded to the second external terminal. Accordingly, welding the first terminal piece portion and the second terminal piece portion enables the first battery cell and the second battery cell to be electrically connected.

Now, when welding the first terminal piece portion and the second terminal piece portion, it is preferable to keep the relative positions thereof constant, but when the first terminal piece and the second terminal piece are positioned using a jig, it is necessary to ensure space between the first battery cell and the second battery cell to dispose the jig, which is undesirable from the perspective of energy density of the battery pack.

Here, in the present aspect, the first terminal piece portion includes a first joining portion that is welded to the first external terminal, and a first flat portion that is integral with the first joining portion and has a planar shape with a thickness direction thereof being the above-mentioned array direction, and is capable of applying a biasing force to the one side of the array direction.

On the other hand, the second terminal piece portion includes the second joining portion that is welded to the second external terminal, and the second flat portion that is integral with the second joining portion and has a planar shape with the thickness direction thereof being the above-mentioned array direction, and is also capable of applying a biasing force to the other side of the array direction.

Thus, according to this aspect, the first flat portion of the first terminal piece portion and the second flat portion of the second terminal piece portion are in a state of being pressed against each other, and can be welded together while maintaining the relative positions thereof constant.

In a battery pack manufacturing method according to a second aspect, between a first battery cell and a second battery cell that are arrayed adjacently to each other in an array direction, in a state in which a first flat portion, that is planar in shape, of a first terminal piece portion that is made of metal and is provided on a portion, on one side in the array direction, of a first case housing a first electrode assembly of the first battery cell, and is also electrically connected to the first electrode assembly, and a second flat portion, that is planar in shape, of a second terminal piece portion that is made of metal and is provided on a portion, on another side in the array direction, of a second case housing a second electrode assembly of the second battery cell, and is also electrically connected to the second electrode assembly, are pressed against each other, the first flat portion and the second flat portion are welded together.

According to the battery pack manufacturing method according to the second aspect, the first battery cell and the second battery cell are arrayed in a state adjacent to each other.

Then, in these array directions, the first flat portion and the second flat portion are welded, in a state in which the first flat portion, that is planar in shape, of the first terminal piece portion that is made of metal and is provided on a portion, on one side in the array direction, of the first case housing the first electrode assembly of the first battery cell, and is also electrically connected to the first electrode assembly, and the second flat portion, that is planar in shape, of the second terminal piece portion that is made of metal and is provided on a portion, on another side in the array direction, of the second case housing the second electrode assembly of the second battery cell, and is also electrically connected to the second electrode assembly, are pressed together.

Accordingly, in the present aspect, the first flat portion of the first terminal piece portion and the second flat portion of the second terminal piece portion can be welded together while maintaining a constant relative position therebetween, without using a jig.

As described above, the battery pack and the battery pack manufacturing method according to the present disclosure have the excellent effect of being able to stably connect electrodes that are provided on the sides of the battery cells while ensuring energy density.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a configuration of a battery pack according to a first embodiment;

FIG. 2 is a front view schematically illustrating a configuration of a primary portion in a battery cell of the battery pack according to the first embodiment;

FIG. 3 is a perspective view schematically illustrating a configuration of a primary portion in a battery cell of a battery pack according to a second embodiment; and

FIG. 4 is a front view schematically illustrating a configuration of the primary portion in the battery cell of the battery pack according to the second embodiment.

### DETAILED DESCRIPTION OF EMBODIMENTS

### First Embodiment

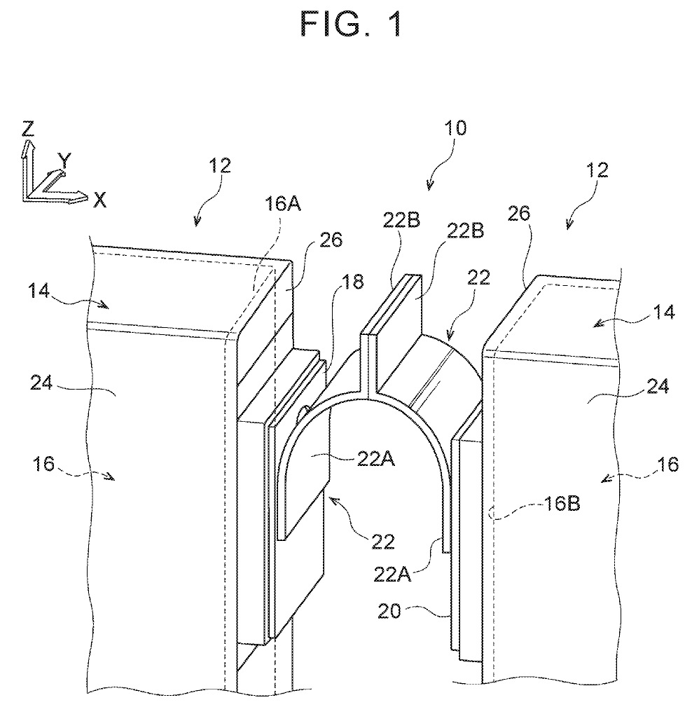

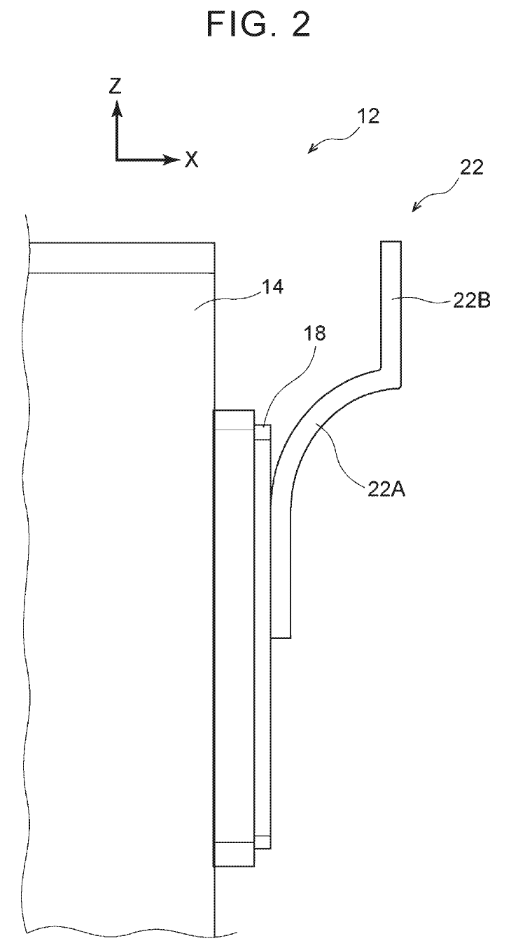

A configuration of a battery pack according to a first embodiment of the present disclosure will be described below with reference to FIGS. 1 and 2. A "battery pack 10" according to the present embodiment can be installed in the underside of a floor portion of a vehicle that is omitted from illustration, such as a hybrid electric vehicle, a plug-in hybrid electric vehicle, a battery electric vehicle, or the like. This battery pack 10 includes an aluminum alloy battery case that makes up an outer shell thereof, and a plurality of "battery cells 12" housed in the battery case.

Note that for the sake of convenience, in each of the drawings in the present embodiment, an arrow X will be referred to as width direction of the battery cell 12 (hereinafter, simply “width direction”), an arrow Y will be referred to as thickness direction of the battery cell 12 (hereinafter, simply “thickness direction”), and an arrow Z will be referred to as height direction of the battery cell 12 (hereinafter, simply “height direction”). Also, one of the width direction, the thickness direction, and the height direction is orthogonal to the two other directions.

As illustrated in FIG. 1, the battery cell 12 includes a "case 14" that makes up an outer shell thereof, an "electrode assembly 16" that is disposed inside the case 14, an anode side current collector terminal that is omitted from illustration, a cathode side current collector terminal that is omitted from illustration, an “external terminal 18”, an “external terminal 20”, and a pair of "terminal piece portions 22".

The case 14 is configured including a case body 24 made of an aluminum alloy that makes up a main portion thereof, and a pair of sealing plates 26 made of an aluminum alloy that makes up end portions in the width direction thereof. The case body 24 has a rectangular tubular shape with both sides open in the width direction.

On the other hand, the sealing plates 26 have a rectangular plate shapes as viewed from the width direction, with a plate thickness direction being the width direction and also a longitudinal direction being the height direction. Opening portions of the case body 24 are sealed off by the sealing plates 26. That is to say, the sealing plates 26 make up part of sides of the battery cell 12.

The electrode assembly 16 is configured including a power generating element that makes up a main portion thereof and also functions as a storage unit for electric power in the battery cell 12, an “anode current collector 16A”, and a “cathode current collector 16B”.

The anode current collector 16A makes up an end portion, on one side in the width direction, of the electrode assembly 16, and the cathode current collector 16B makes up an end portion, on the other side in the width direction, of the electrode assembly 16.

The anode side current collector terminal is made of copper as one example, and a main portion thereof is housed in one side portion of the case 14 in the width direction. The anode side current collector terminal is joined to the anode current collector 16A of the electrode assembly 16 at a joining portion, omitted from illustration, made by resistance welding or the like, and is in a state of being electrically connected to the anode current collector 16A.

On the other hand, the cathode side current collector terminal is made of aluminum as one example, and a main portion thereof is housed in the other side portion of the case 14 in the width direction. This cathode side current collector terminal is joined to the cathode current collector 16B of the electrode assembly 16 at a joining portion, omitted from illustration, made by resistance welding or the like.

The external terminal 18 is in the form of a rectangular plate as viewed in the width direction, is made of copper as one example, in the same way as the anode side current collector terminal, and is also disposed on the sealing plate 26 on one side in the width direction, at a portion on an upper side thereof in the height direction. Note that the external terminal 18 is electrically connected to the anode side current collector terminal.

On the other hand, the external terminal 20 is made of aluminum as one example, in the same way as the cathode side current collector terminal, and is also disposed on the sealing plate 26 on the other side in the width direction, at a portion on an upper side thereof in the height direction. Note that the external terminal 20 is electrically connected to the cathode side current collector terminal. The external terminal 18 and the external terminal 20 each have a terminal piece portion 22.

As illustrated in FIG. 2, the terminal piece portion 22 is formed by bending a metal plate material by pressing or the like, and is configured including a "joining portion 22A" and a "flat portion 22B."

Specifically, a portion on a lower side of the joining portion 22A in the height direction extends linearly in the height direction, and also an upper side portion in the height direction is curved so as to be convex toward an inner side in the width direction of the battery cell 12 and also toward an upper side in the height direction. Note that the joining portion 22A is welded to the external terminal 18 or the external terminal 20.

On the other hand, the flat portion 22B is provided integrally with the joining portion 22A and also has a flat shape extending upward in the height direction from the joining portion 22A with the thickness direction being the width direction. Also, when the flat portion 22B of the terminal piece portion 22 that is configured as described above is pressed toward the inner side in the width direction of the battery cell 12, restoring force thereof can apply a biasing force from the flat portion 22B to the outer side in the width direction of the battery cell 12.

Further, the battery cells 12 are disposed in a row in the width direction, and in the present embodiment, the width direction can be regarded as being a direction of array of the battery cells 12. In the battery cells 12 that are disposed adjacently to each other in the width direction, distal end portions of the terminal piece portions 22 that are adjacent to each other are joined at a joining portion that is omitted from illustration, by laser welding or the like, such that the battery cells 12 that are disposed adjacently to each other in the width direction are in a state of being electrically connected to each other.

Note that in the present embodiment, among the battery cells 12 that are disposed adjacently to each other in the width direction, the battery cell 12 that is located on the other side in the width direction functions as a first battery cell, and the battery cell 12 that is located on the one side in the width direction functions as a second battery cell.

In the battery cell 12 functioning as the first battery cell, the electrode assembly 16 functions as a first electrode assembly, the anode current collector 16A of this electrode assembly 16 functions as a first electrode, the case 14 functions as a first case, the external terminal 18 functions as a first external terminal, and the terminal piece portion 22 provided on this external terminal 18 functions as a first terminal piece portion. Also, the joining portion 22A of this terminal piece portion 22 functions as a first joining portion, and the flat portion 22B of this terminal piece portion 22 functions as a first flat portion.

On the other hand, in the battery cell 12 functioning as the second battery cell, the electrode assembly 16 functions as a second electrode assembly, the cathode current collector 16B of this electrode assembly 16 functions as a second electrode, the case 14 functions as a second case, the external terminal 20 functions as a second external terminal, and the terminal piece portion 22 that is provided on this external terminal 20 functions as a second terminal piece portion. Also, the joining portion 22A of this terminal piece portion 22 functions as a second joining portion, and the flat portion 22B of this terminal piece portion 22 functions as a second flat portion.

### Effects and Advantages of the Present Embodiment

Next, the effects and advantages of the present embodiment will be described.

In the present embodiment, as illustrated in FIG. 1, the battery cells 12 are provided arrayed adjacently to each other in the width direction. Of these battery cells 12, the battery cell 12 that is disposed on the other side in the width direction includes the external terminal 18 that is provided on a portion, on the one side in the width direction, of the case 14 that houses the electrode assembly 16, i.e., on the side of the battery cell 12 and is also electrically connected to the anode current collector 16A of the electrode assembly 16, and the terminal piece portion 22 that is made of metal and is welded to the external terminal 18.

On the other hand, out of the battery cells 12 that are arrayed adjacently in the width direction, the battery cell 12 that is disposed on the one side in the width direction includes the external terminal 20 that is provided on a portion, on the other side in the width direction, of the case 14 that houses the electrode assembly 16, i.e., on the side of the battery cell 12 and is also electrically connected to the cathode current collector 16B of the electrode assembly 16, and the terminal piece portion 22 that is made of metal and is welded to this external terminal 20. Accordingly, welding the terminal piece portion 22 of the battery cell 12 that is disposed on the other side in the width direction to the terminal piece portion 22 of the battery cell 12 that is disposed on the one side in the width direction enables the battery cells 12 that are arrayed adjacently to each other in the width direction to be electrically connected.

Now, when welding these terminal piece portions 22 together, it is preferable to keep relative positions thereof constant, but when these are positioned using a jig, it is necessary to ensure space to dispose the jig between the battery cells 12 that are arrayed adjacently to each other in the width direction, which is undesirable from the perspective of energy density of the battery pack 10.

Here, in the present embodiment, in the terminal piece portion 22, on the one side in the width direction, of the battery cell 12 on the other side in the width direction, out of the battery cells 12, the joining portion 22A is welded to the external terminal 18, and the flat portion 22B of this joining portion 22A is capable of applying a biasing force to the one side in the width direction.

On the other hand, in the terminal piece portion 22, on the other side in the width direction, of the battery cell 12 on the one side in the widthwise direction, out of the battery cells 12, the joining portion 22A is welded to the external terminal 20, and the flat portion 22B of this joining portion 22A is capable of applying a biasing force to the other side in the width direction.

Accordingly, in the present embodiment, between the battery cells 12 that are arrayed adjacently to each other in the width direction, the flat portion 22B of the terminal piece portion 22 on the other side in the width direction and the flat portion 22B of the terminal piece portion 22 on the one side in the width direction are in a state of pressing against each other, and can be welded while keeping relative positions thereof constant.

More specifically, when the battery pack 10 is manufactured, the battery cells 12 are arrayed adjacent to each other in the width direction in the battery case. Then, as described above, the flat portion 22B of the terminal piece portion 22 on the other side in the width direction and the flat portion 22B of the terminal piece portion 22 on the one side in the width direction are pressed against each other between these battery cells 12 in the array direction of these battery cells 12, in which state these flat portions 22B are welded to each other.

Thus, according to the present embodiment, the battery cells 12 that are arrayed adjacently to each other in the width direction can be welded while maintaining the relative position constant between the flat portion 22B of the terminal piece portion 22 on the other side in the width direction and the flat portion 22B of the terminal piece portion 22 on the one side in the width direction, without using a jig.

As described above, according to the present embodiment, the electrodes that are provided on the sides of the battery cells 12 can be stably connected to each other, while ensuring the energy density of the battery pack 10.

### Second Embodiment

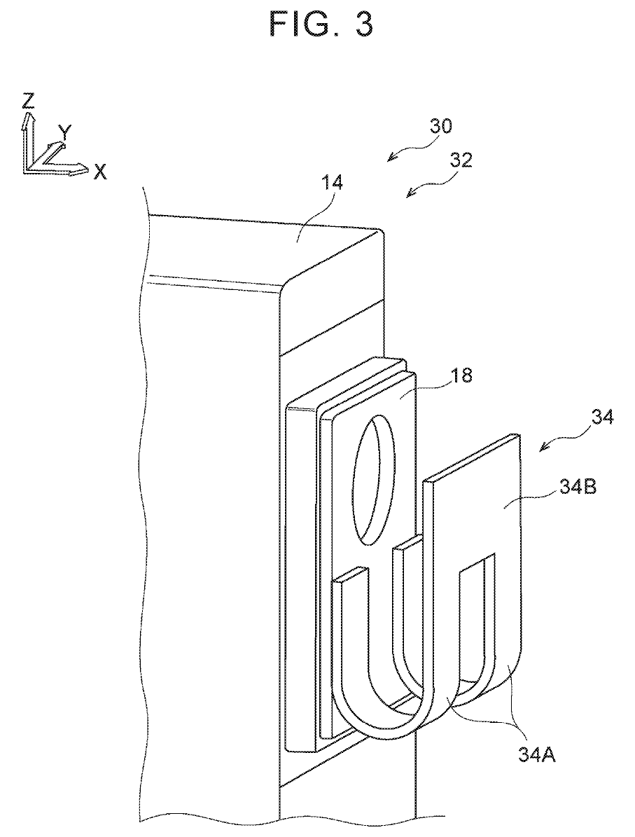

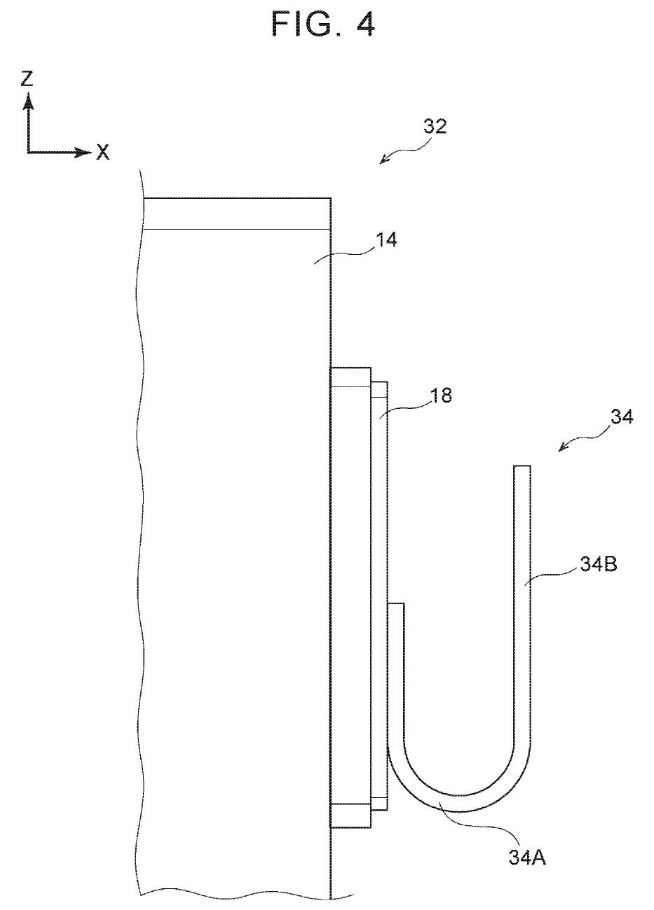

A "battery pack 30" according to a second embodiment of the present disclosure will be described below with reference to FIGS. 3 and 4. Note that the same components as those in the first embodiment described above are denoted by the same reference numerals, and description thereof will be omitted.

This battery pack 30 has a configuration basically similar to that of the first embodiment that is described above, but the shape of the “terminal piece portion 34” that is provided on a “battery cell 32” is different from that of the terminal piece portion 22.

This terminal piece portion 34 is formed by bending a metal plate material by pressing or the like, and is configured including a pair of “joining portions 34A” and a "flat portion 34B".

Specifically, the joining portions 34A are U-shaped with a lower side in the height direction being convex as viewed from the thickness direction, and are disposed across a spacing from each other in the thickness direction, with the portions thereof on the case 14 side being welded to the external terminal 18 or to the external terminal 20.

On the other hand, the flat portion 34B is provided continuous from the joining portions 34A at the opposite side portion from the case 14, and is also planar in shape and extends upward in the height direction from the joining portions 34A with the thickness direction as the width direction. When the flat portion 34B of the terminal piece portion 34 that is configured as described above is pressed toward the inner side in the width direction of the battery cell 12, restoring force thereof can apply a biasing force from the flat portion 34B to the outer side in the width direction of the battery cell 12.

According to this configuration, basically the same effects and advantages as those of the first embodiment that is described above are achieved. Also, according to the present embodiment, the joining portions 34A and are U-shaped with the lower side in the height direction being convex as viewed from the thickness direction, and accordingly the amount of deformation in the width direction of the terminal piece portion 34 can be ensured.

What is claimed is:

1. A battery pack comprising:
a first battery cell and a second battery cell that are arrayed adjacently to each other in an array direction, wherein
the first battery cell includes
a first external terminal that is provided on a portion, on one side in the array direction, of a first case housing a first electrode assembly, and that is also electrically connected to a first electrode of the first electrode assembly, and
a first terminal piece portion that is made of metal, and that includes a first joining portion that is welded to the first external terminal, and a first flat portion that is provided integrally with the first joining portion, the first flat portion being planar in shape with a thickness direction matching the array direction, and that is also configured to apply a biasing force to the one side in the array direction, and
the second battery cell includes
a second external terminal that is provided on a portion, on another side in the array direction, of a second case housing a second electrode assembly, and that is also electrically connected to a second electrode of the second electrode assembly, and
a second terminal piece portion that is made of metal, and that includes a second joining portion that is welded to the second external terminal, and a second flat portion that is provided integrally with the second joining portion, the second flat portion being planar in shape with the thickness direction matching the array direction, and that is also configured to apply a biasing force to the other side in the array direction and also is welded to the first flat portion.

2. A battery pack manufacturing method, wherein,
between a first battery cell and a second battery cell that are arrayed adjacently to each other in an array direction,
in a state in which a first flat portion, that is planar in shape, of a first terminal piece portion that is made of metal and is provided on a portion, on one side in the array direction, of a first case housing a first electrode assembly of the first battery cell, and is also electrically connected to the first electrode assembly, and
a second flat portion, that is planar in shape, of a second terminal piece portion that is made of metal and is provided on a portion, on another side in the array direction, of a second case housing a second electrode assembly of the second battery cell, and is also electrically connected to the second electrode assembly, are pressed against each other,
the first flat portion and the second flat portion are welded together.
